(19) United States
(12) Patent Application Publication
(10) Pub. No.: US 2002/0078070 A1
(43) Pub. Date: Jun. 20, 2002

(54) Calendar software application with personal and historical data

(75) Inventors: Larry J. Eshelman, Ossining, NY (US); Srinivas Gutta, Buchanan, NY (US); James A. Hoekema, Newburgh, NY (US); John G. Milanski, Tarrytown, NY (US); Daniel L. Pelletier, Lake Peekskill, NY (US); Hugo J. Strubbe, Yorktown Heights, NY (US)

Correspondence Address: Corporate Patent Counsel, U.S. Philips Corporation, 580 White Plains Road, Tarrytown, NY, 10591, US

(73) Assignee: PHILIPS ELECTRONICS NORTH AMERICA CORP.

(21) Appl. No.: 09/739,475

(22) Filed: Dec. 18, 2000

(51) Int. Cl. G06F 7/00

(52) U.S. Cl. 707/200

(57) ABSTRACT

A combined calendar/diary application leverages several input mechanisms to enrich the historical record kept by a user. First, the application classifies events sensed by sensors and software monitors to capture and classify data indicative of events of significance to the user. It then requests additional information from the user to create a diary entry. Second, on the basis of the same event data, it may add the classification data to the diary as indicia of financial, emotional, or other states of the user or environment. Third, the system augments appointment using other data, including user input. Fourth, data is extracted from other sources for direct inclusion in the diary database. For example, contemporaneous news data from an Internet news feed may be added. Fifth, the application may periodically prompt the user for diary entries. Sixth the application may support deliberate diary-entry procedure as is done with current diary applications.

### BACKGROUND OF THE INVENTION

1. Field of the Invention

The invention relates to the storage of personal information in a calendar system that augments appointment and diary entries with other information such as outstanding news events, weather, significant communications, etc.

2. Background

Calendar applications are known for providing the functional equivalent of a paper calendar. Advanced applications incorporate additional features such as to-do lists, and news and historical event information from an external feed such as an Internet server. In most calendar applications, when an appointment is entered on a given day and time, a new record is formed and preserved. The record can be later displayed on a current or future day/week/month-formatted display. After the appointment date is past, the user usually has the ability to look backwardly and see the same schedules. In this way, the system acts somewhat like a diary of past events. However, as a diary of past events. calendars are not informative or pleasant to read. Often they can be cryptic and provide little context for understanding their relevance, particular when observed years later by another party.

Another genre of prior art are baby books, personal diaries, scrap books, etc. These may provide a pleasurable and educational experience for readers wanting to review the events that make up one's life. However, few people feel they have the time or energy to create such a record.

### SUMMARY OF THE INVENTION

Briefly, a diary/calendar application provides automatic assistance by augmenting appointment data ordinarily placed in prior art calendar applications with public and private data relevant to one's life. The purpose is to generate, over time, a record of events in one's life in the manner of a scrap book (baby book) or diary. One mode of data augmentation is automatic. The user selects what sorts of current events information the user would like to save in the record, and an agent or other equivalent device gathers data automatically into the record with selective modification as discussed below. Another mode of augmentation is through automatic devices to help flesh out and make the user's records more readable and understandable. For example, automatic fill-in with prompting may provide greater detail in records so that otherwise cryptic mnemonics indicating appointments, are decipherable at a future date. Still another mode of augmentation is a periodic request by the diary/calendar application for information on the user's activities to make a record of events that do not correspond to appointment records.

Public data may be automatically incorporated, either directly or by incorporation of a reference pointer, which refers to publicly-known events that occurred on a given day. Also, personal data may be obtained by prompting the user (or automatically without prompting) in a minimally intrusive manner so as to gather enough data to make a comprehensible record. For example, at some point during or after the creation of an appointment record, the user may be given choices for fleshing out a description of an appointment that the user is entering, or had entered. To speed the process, the user may be shown various templates. Preferably, such templates may be created by the user or at least incorporate portions provided by the user. Here is an example. The user enters “Carolyn, Forum 8 PM.” The diary/calendar application, having access to the user's contact file, can identify persons named Carolyn that are known to the user. The system may prompt the user with a combo box (also called a list box) object showing the existing alternative identifiers for “Carolyns” in the contact file and allow the user to select one. The combo box may have a selection for “new” selection of which causes the system to prompt the user for contact information so that this appointment can be later recalled with greater clarity from a complete and descriptive record. Similarly, the diary/calendar application may attempt to identify “Forum” and generate a similar combo box which may be employed in the same manner. If several locations nearby contain the word “forum,” the diary/calendar application may generate a combo box from this data. The result of the above interaction would be a more complete and detailed record of an appointment which may serve as a clear understandable record of a past event at some point, perhaps years, after the appointment date. Other sources of data that may be used to cross-reference appointment data with a greater context include email files, time-billing reports, voice mail (converted to text), audio and video recognition processes (e.g., building fire alarm goes off, classified as a fire alarm event, and added to diary).

Records recalling particular events may be entered into the calendar. The idea is that the user's calendar can be populated with public information from, say, a news feed on the Internet. There are several ways in which this data may be shaped by the user to form a more personal historical record of a user's life. First, the user may filter and sort the subject matter according to his personal preferences. Second the user may add comments to the material from the public source. For example, if the user likes certain sports, the user could receive records of sporting events that were of interest. The calendar could serve as the user's news source and certain articles digitally clipped by the user and placed in the diary. The articles may be annotated by the user, cropped, added to with selected pictures, etc. Thus, the personal record of public events may be personalized by the user.

One of the most important things a user can do to create a rich record of events is simply to record what the user has done as one would record events and thoughts in a diary. The calendar can take some of this burden away by leveraging appointment, public, and other data as discussed above. To assist in the generation of diary-like records that are unrelated to appointments or public data, the diary/calendar application may request the user to explain events that it senses (for example, in the fire drill example mentioned, it could request an explanation for what just happened). Another trigger for requests could be the addition or deletion of files from the computer. For example, if the user downloads graphic files consistent with a digital camera format (e.g., jpg files), the diary/calendar application could invite the user to add new records through the diary/calendar application. Requests for information about current activities or recent noteworthy events could come at periodic intervals or could be prompted in response to noteworthy events. Say, for example, the user reads email for a threshold interval at a certain time of day, for example in the morning, at the start of work. The diary/calendar application could ask if any particularly noteworthy email messages were received and ask the user if he/she would like to make a diary entry. Video, audio, or other kinds of sensor classification could identify uncommon situations and trigger a similar prompt. For example, if someone enters the user's office and speaks for a while, the system could prompt for an entry. The system could even record parts of the conversation and selectively store this away in the diary as speech converted to text or as audio files (subject to approval and/or modification by the user).

With a large variety of inputs, such as the inventory of household goods stored on a domestic server, files stored on the computer, security system information, etc., the diary/calendar application could store composite or “lump” parameters indicative of financial, social, personal and other conditions extant at any given time. Such lump parameters may represent an index derived from multiple specific parameters. For example, one such lump parameter (or “index,” if preferred) might be percentage breakdown of entertainment expenses or goods associated with a grand lifestyle. Such an index could be derived from parameters that indicate profligate consumption such as: long term inventory level of caviar and champagne, high checking account balance and low savings, etc. Another index could be productivity, indicated for example by the number of pages of text typed into a computer, emails transmitted to working colleagues, etc. Still another could be a social index into which is folded the number of appointments the user keeps, the number of gifts in the user's budget, etc. Basically, the idea here is to leverage well known data-mining techniques to derive indicia of the climate or experience of a user over a period of time and to incorporate that information in the diary/calendar application.

For reviewing purposes, the diary/calendar application can take on the appearance of any of the current generation of diary applications. This includes online diaries where the contents are available to the public and outsiders permitted to add comments. The system accepts multimedia data such as video, graphic, sound, etc. These objects can be added, and formatted, according to any suitable scheme.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is a block diagram of a hardware system on which the present diary/calendar application may be run.

FIG. 2 is a block diagram of the functional features of the diary/calendar application of the present invention.

### DETAILED DESCRIPTION OF THE PREFERRED EMBODIMENTS

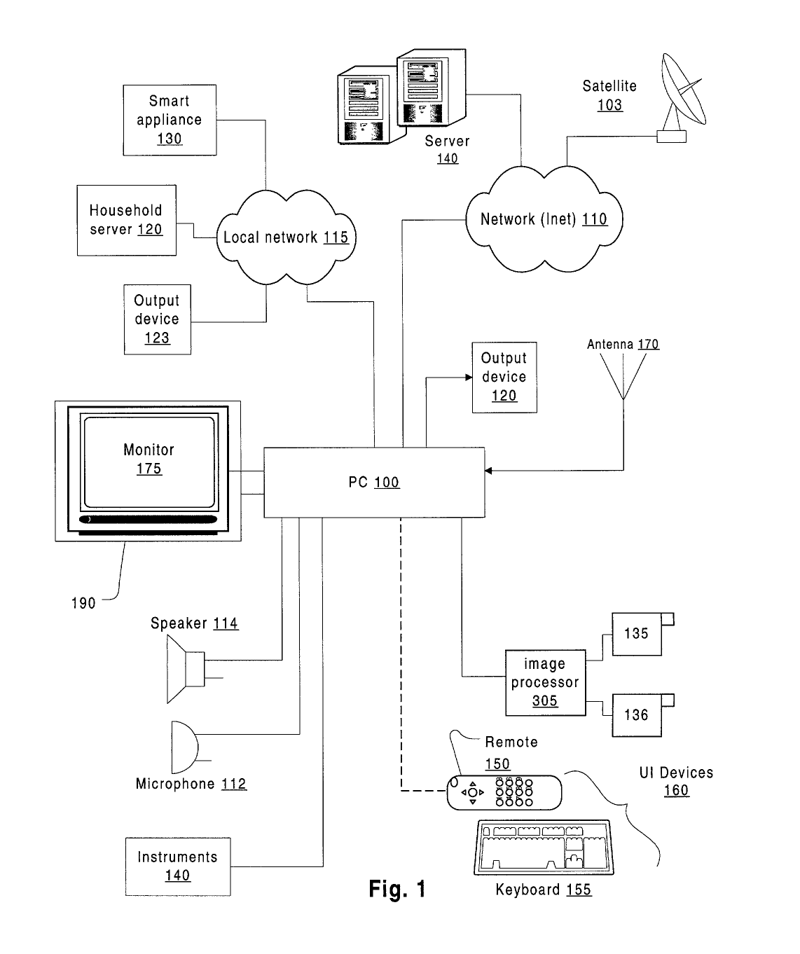

Referring to FIG. 1, a system on which the diary/calendar application of the current invention may be run has, at its heart, a computer 100. The Computer 100 may receive input from various sources for example, an image processor 305 connected to cameras 135 and 136, conventional user interface devices 160 such as a remote control 150 and the keyboard 155. Other input devices may include a microphone 112, various instruments 140 such as temperature sensors, position sensors, security switches, proximity sensors, electrical load sensors, ambient light sensors, and alternative user interface devices such as a mouse (not shown separately), etc. Data may be gathered by the computer 100 through local or wide area or Internet networks 115 and 110. Devices connected to the local network 115 may include smart appliances 130, a household server 120, or output devices 123, which may include displays, audio outputs, wireless devices (not shown separately), etc. The household server 120 may store data such as inventory data for perishable goods and food, other supplies such as used for arts and crafts projects, materials used for hobbies, etc. The smart appliances 130 could include a microwave oven with an interface such as a bar code reader and a display, a television set, a stereo (not shown separately), etc. The computer 100 may directly output through a monitor 175.

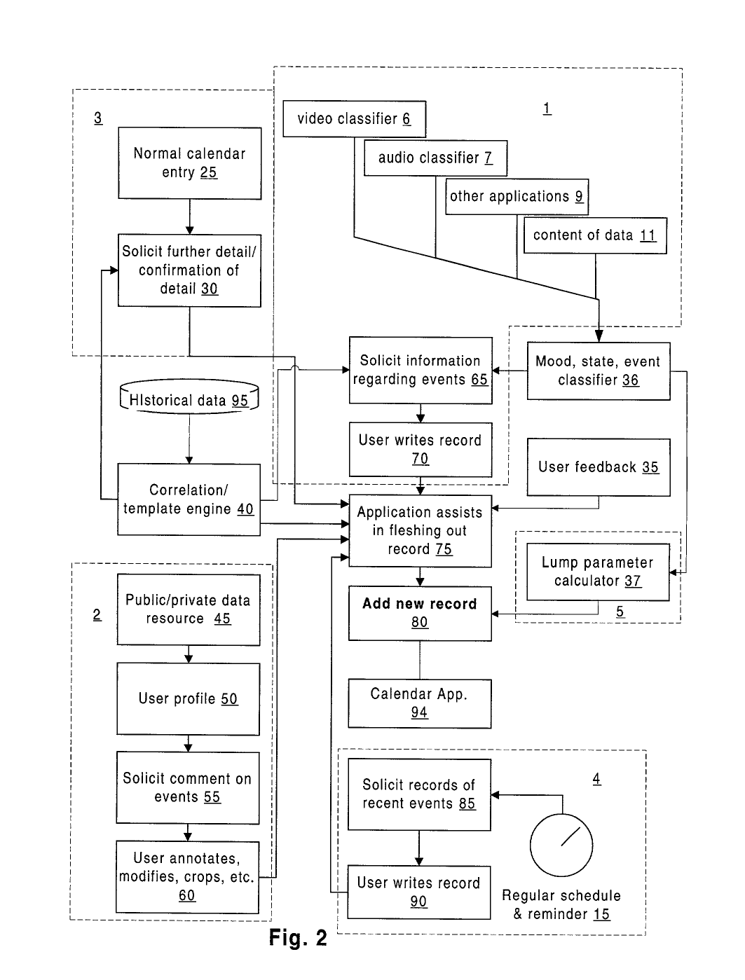

Referring to FIG. 2, five basic methods of adding data to the diary/calendar application of the invention are presented for illustration. A first method 1 adds records solicited by the diary/calendar application in response to some triggering event. The solicitation may be, for example, in the form of a request for an explanation 65 for something whose occurrence was sensed and classified as noteworthy by the diary/calendar application system. A second method 2 adds records from a public/private data resource 45 such as an Internet news feed or local (household) network on which household inventory is recorded and periodically updated. The data is filtered through a user profile 50 and augmented by the user to generate new records. A third method 3 adds records that are otherwise normal calendar entries such as for appointments, except that the system, in concert with the user, augments these to make them more understandable and enriched by soliciting/adding further information 30. A fourth method 4 adds records that are solicited on some periodic basis such as at certain times of the day, immediately after a logon on a weekly basis, during lunch, etc. The latter may be specifically oriented to the creation of a diary record. A fifth method 5 adds records to automatically record lump parameters or indices that relate to some over-arching state or condition, such as a mood of the user, the average balance in a checking account, the amount of time television is watched, etc. These may be folded into more sophisticated multiple-variable indexes indicative of emotional state, prosperity level, sociability, depressive pathology, etc. A sixth and final method (not shown) may be according to a deliberate diary-entry procedure as is done with current diary applications.

In all these methods, the diary/calendar application may attempt to provide assistance to the user by offering to make complete understandable records using information that is available to it and requesting confirmation. This latter feature relies on a correlation/template engine 40, which tries to match prior interaction data and external data, such as personal files, with the text or other input entered automatically or by the user.

The third method begins with a normal calendar entry 25. For example, the user may be entering an appointment with a doctor or to meet a friend for a meal. The system may automatically, or conditionally, respond to the entry with a request 30 for further detail about the future event. For example, if the user's entry is cryptic and not fully recognized, the system may invite the user, via a dialog box, to embellish the entry so that it is more understandable. For example, if the entry identifies someone, the user may enter information that makes the reference more specific, for example by adding the person's last name. Preferably, the diary/calendar application assists 75 in the process of augmenting by identifying more detailed information that matches the incomplete data entered. This may be done with a correlation/template engine 40. The correlation/template engine 40 may run in the background looking for matches to what is entered. Among the data it would review are historical data 95, which is data that has been entered into the diary before in more complete detail. Other data that might be reviewed are email messages, the most recent ones first, contact lists, or any other records that might provide the details of the short form (or ambiguous form—e.g., a typo) that was entered in the calendar. This candidate data would be presented to the user as alternative options to allow the user to select from, say, a dropdown list without having to type in the person's last name. The user then enters the detailed data or confirms an option presented 35 by the diary/calendar application.

Thus, in an example, the use enters just the first name of a person and a place along with the time. The diary/calendar application attempts to find data relating to the person from previous diary entries, stored in historical data 95, email, word processing files of letters, contact list, etc. It then generates a selection list, such as a combo box, for the user to select from. Alternatively, auto-completion may be used. In this context, auto-completion would fill in a complete candidate word or phrase as it is entered by the user. For example, the user begins typing a last name and the diary/calendar application fills in the rest from the same information base until the correct last name appears. Then the user confirms it without finishing the typing of the rest of the name. Similar features are available in various applications such as Microsoft® Internet Explorer® 5, Microsoft® Outlook 97®, and many others.

The first method 1 is basically a request for diary entries. However, rather than simply make the request without prompting, the system attempts to make the request for information at expeditious times. For example, the diary/calendar application may provide a process that monitors other applications 9. A mood, state, event classifier 36 monitoring text and other data generated by the user interacting with such applications may classify the state of the user, his/her environment, activities, etc. Such a process may generate an indication that the user has been reading email for a period of time. This may trigger, upon exiting of the email client, or alternatively, after the client has been active for a threshold period of time, a solicitation for information regarding the email received or sent 65. The request may be designed for the particular application that prompted the request. In the example, a dialog box may appear asking if any noteworthy email letters arrived or if the user would like to attach any of them to today's diary record. Note that attaching files or other data objects to text diary entries is contemplated as included within the idea of creating or writing a diary entry. The user may respond by indicating or dragging and dropping attachments to an appropriate user interface object and/or writing a diary entry or simply dismiss the invitation to enter.

A U.S. Pat. 5,987,415, the entirety of which is hereby incorporated by reference as if fully set forth herein and which is assigned to Microsoft, describes a system in which a network model of a user's emotional state and personality are inferred and the inference used to select from among various alternative paraphrases that may be generated by an application. The approach is inspired by trouble-shooting systems in which a user attempts to obtain information about a problem, such as a computer glitch, using a machine-based system that asks questions to help the user diagnose and solve the problem himself. The approach can be summarized as follows. First, the system determines a mood of a user based on a network model that links alternative paraphrases of an expected expression. The mood and personality are correlated with a desired mood and personality of the engine that generates the feedback to the user. Mood descriptors are used to infer the mood of the user and the correlation process results in mood descriptors being generated and used to select from among alternative paraphrases of the appropriate substantive response. In summary there is a stochastic model used to determine the mood and personality projected by the user's response. As in this system, the independence of mood from the meaning of spoken and text input from a user permits the mood to serve as an input vector that may be recorded in the diary by the calendar/diary application or used to trigger requests for the user to enter new diary records. Thus, a user looking back, would see this emotional index along with other specific events he recorded or which were recorded automatically.

The diary/calendar application may attempt to build a classification engine to determine what times are the most favorable for obtaining diary records. For example, it may employ a neural network with inputs such as time of day, type of software activity (e.g., working with graphic, video, or text files, working with email, video-conferencing, checking stocks, etc.), type of physical activity (quiet or in and out of the house/office), number of visitors, etc. These and other inputs may be used with the positive and negative feedback of the user's response to the request for diary entries to build a smart system that requests entries at optimal times.

Other examples of input from external applications that may be used to prompt the calendar/diary application to solicit information regarding their respective events 65 include:

1. Word processing application drafting text (a letter) containing the name of a person in a personal contact file.

2. Word processing or email application being used and shows an unusually large number of inflammatory words being used. Eudora® 5 Moodwatch® feature has a classifier for this.

3. Unusual use of any of a variety of applications, for example video-conferencing.

4. A large number of emails to and from the same entity.

5. Security system monitoring program indicates a large number of incidents of doors opening and closing.

6. The content of data 11 entered by the user into the calendar or diary parts of the calendar/diary application itself.

Audio and video classifiers 7 and 6 may also generate triggers of significant events to which the calendar/diary application may respond by soliciting information regarding the event 65. The audio classifier 7 may include a speech recognition process which can be used to identify what is being said in the user's environment using known techniques. The audio classifier 7 may also be trained to recognize various classes of sounds, such as a door opening, speech without recognition, sudden unusual noises, sighing, yelling, etc. The audio and video classifiers 7 and 6 may also be used to extract information about the mood of the user as described in a commonly assigned pending U.S. application Ser. No. 09/699,577 filed Oct. 30, 2000, entitled USER INTERFACE/ENTERTAINMENT DEVICE THAT SIMULATES PERSONAL INTERACTION AND RESPONSE TO USER'S MENTAL . . . ”. The foregoing patent application is hereby incorporated by reference in its entirety as if fully set forth herein.

The second method 2 takes data from a public or private data resource 45 such as the Internet, a domestic or office network, a wireless network, etc. A preferred example of such data is a news feed. The latter may be filtered by a user profile 50. Also, the material automatically selected by the calendar/diary application may be presented to the user and comments solicited on these events 55. Here the user may annotate, clip, delete, or otherwise modify 60 proposed entries into the diary portion of the calendar/diary database. The presentation of this data may occur on a periodic basis or in response to a live feed that presents news flashes. Alternatively, the review process may be combined with a news reader application portion of the calendar/diary application which allows the user to review the content for informational purposes and for recording purposes at the same time.

The fourth method 4 is simply a scheduled prompt or reminder to make entries into the diary. This latter function preferably provides the user the ability to select certain times or events in which to be prompted to enter diary records. For example, the user may be prompted after each visit to see his/her children, appointments for which can be found in the calendar portion of the calendar/diary application. For another example, the user could be prompted at a certain time each day or each time he/she closes a certain application. Still another example is when an application is entered (or the computer 100 is booted) after a threshold interval following the last one in which the user made diary entries.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of generating a diary record, comprising the steps of:
classifying at least one of audio, video, and text input to a computer and generating an indicator of an event responsively thereto;
said event being unrelated to a calendar/diary application;
prompting a user, by a calendar/diary application, to enter data relating to said event for incorporation in an historical record of events pertaining to a user;
accepting user input responsive to said step of prompting;
adding a record to a database defining said historical record including at least one of data resulting from said step of classifying and data resulting from said step of accepting.

2. A method as in claim 1, wherein said at least one of data resulting from said step of classifying and data resulting from said step of accepting includes data resulting from said step of classifying and data resulting from said step of accepting.

3. A method as in claim 1, wherein said event includes writing an email letter.

4. A method as in claim 1, wherein said event includes writing a letter on a text application other than said calendar/diary application.

5. A method as in claim 1, wherein said event includes a change in a mood of said user.

6. A method of generating a diary record, comprising the steps of:
accepting data towards the making of a new record in a calendar application;
prompting a user for greater detail in an event defined by said record;
automatically generating a diary record responsive to a result of said steps of accepting and prompting.

7. A method as in claim 6, wherein said step of automatically generating includes:
correlating selected user input from said step of accepting with data in an external data store; and
generating a detailed description of a portion of said data accepted in said step of accepting responsively to said step of correlating whereby additional data from said external data is used to clarify said data accepted in said step of accepting.

8. A method as in claim 7, wherein said step of automatically generating further includes requesting and accepting a confirmation by said user of said description.

9. A method as in claim 7, wherein said external data store is at least one of a contact data store, a word processing file store, an email data store, and a calendar application.

10. A method of generating a diary record, comprising the steps of:
detecting one of a passage of time since an entry of a record into a diary database and a time of day;
prompting a user to enter a diary entry responsively to said step of detecting;
accepting data to form a new record in a diary;
adding a new record responsive to a result of said step of accepting.

11. A method as in claim 9, wherein said step of accepting includes:
correlating selected user input responsive to said step of prompting with data in an external data store; and
automatically generating a detailed description of a portion of said data accepted in said step of accepting responsively to said step of correlating whereby additional data from said external data is used to clarify said data accepted in said step of accepting.

12. A method as in claim 11, wherein said step of automatically generating further includes requesting and accepting a confirmation by said user of said description.

13. A method as in claim 11, wherein said external data store is at least one of a contact data store, a word processing file store, an email data store, and a calendar application.

14. A method of generating a diary record, comprising the steps of:
extracting current events or historical data from an external data resource;
accepting data descriptive of at least one of an appointment and an event for inclusion in a diary database;
adding data resulting from said step of extracting to data resulting from said step of accepting to said diary database.

15. A method as in claim 14, wherein said step of adding includes accepting user input data indicative of instructions to modify said current events or historical data.

16. A method as in claim 14, wherein said step of adding includes correlating a date corresponding to said current events or historical data with a date diary data entered in said diary database.

17. A method of generating a diary record, comprising the steps of:
accepting user input data descriptive of personal events to be recorded in a diary database;
sensing and classifying states, events, or moods of a user or said user's environment;
generating an index responsive to said step of sensing;
adding said index and said user input to said diary database.

18. A data medium having instructions thereon for implementing a method for generating a diary record, comprising the steps of:
accepting user input data descriptive of personal events to be recorded in a diary database;
sensing and classifying states, events, or moods of a user or said user's environment;
generating an index responsive to said step of sensing;
adding said index and said user input to said diary database.
